(19) United States
(12) Patent Application Publication
(10) Pub. No.: US 2005/0023912 A1
(43) Pub. Date: Feb. 3, 2005

(54) Electric motor for hydromassage bathtubs

(75) Inventors: Chih Min Lin, Tipp City, OH (US); William James Watkins, Tipp City, OH (US); Dwayne Roger Fox, Vandalia, OH (US)

Correspondence Address: MICHAEL BEST & FRIEDRICH, LLP, 100 E WISCONSIN AVENUE, MILWAUKEE, WI, 53202, US

(73) Assignee: A.O. Smith Corporation, Milwaukee, WI (US)

(21) Appl. No.: 10/628,301

(22) Filed: Jul. 28, 2003

(51) Int. Cl. H02K 5/00

(52) U.S. Cl. 310/89

(57) ABSTRACT

An electric motor including a single end frame, a stator, a shaft, a rotor, and a canopy. The stator includes a stator core, a first end fixed relative to the end frame, and a second end. The shaft is supported by the end frame for rotation about a shaft axis. The rotor is connected to the shaft for rotation with the shaft relative to the stator. The canopy is configured to cover at least a portion of the rotor and the second end of the stator during normal operation of the electric motor. A portion of the stator core is exposed between the end frame and the canopy at all times during normal operation of the electric motor.

### BACKGROUND OF THE INVENTION

The present invention relates to electric motors, and more particularly to electric motors utilized with hydromassage bathtubs.

Various electric motors have been utilized to drive pumps associated with hydromassage bathtubs. Nevertheless, a new electric motor for use with hydromassage bathtubs that provides ease of manufacturing, installation, and maintenance would be welcomed by those in the art.

### SUMMARY OF THE INVENTION

Electric motors utilized for hydromassage bathtub applications are commonly located under the bathtub in a confined space. These space limitations often complicate installation and maintenance of the motor. The invention provides an electric motor that is designed to ease installation and maintenance of the motor. The motor is also designed to ease manufacturing of the motor.

In one embodiment, the invention provides an electric motor including a single end frame, a stator, a shaft, a rotor, and a canopy. The stator includes a stator core, a first end fixed relative to the end frame, and a second end remote from the end frame. The shaft is supported by the end frame for rotation about a shaft axis. The rotor includes opposite sides spaced in the direction of the shaft axis and is connected to the shaft for rotation with the shaft relative to the stator. The shaft is only supported on one side of the rotor for rotation about the shaft axis. The canopy is configured to cover at least a portion of the rotor and the second end of the stator during normal operation of the electric motor. A portion of the stator core is exposed between the end frame and the canopy at all times during normal operation of the electric motor. The shaft is not supported by the canopy for rotation about the shaft axis.

In another embodiment, the invention provides an electric motor including a single end frame, a stator, a shaft, a rotor, a canopy, and electrical components for operation of the electric motor. The end frame includes a conduit box. The stator includes a first end fixed relative to the end frame and a second end remote from the end frame. The shaft is supported by the end frame for rotation about a shaft axis. The rotor has opposite sides spaced in the direction of the shaft axis and is connected to the shaft for rotation with the shaft relative to the stator. The shaft is supported on only one side of the rotor for rotation about the shaft axis. The canopy is configured to cover at least a portion of the rotor and the second end of the stator during normal operation of the electric motor. The electrical components are at least partially positioned in the conduit box and are removable from the conduit box without removing the canopy. The shaft is not supported by the canopy for rotation about the shaft axis.

In another embodiment, the invention provides an electric motor including a single end frame, a stator, a shaft, and a rotor. The stator is fixed relative to the end frame. The shaft is supported by the end frame for rotation about a shaft axis. The rotor is connected to the shaft for rotation with the shaft relative to the stator. The end frame includes a surface that is transverse to the shaft axis that the stator is fixed against to locate the stator-relative to the end frame.

In yet another embodiment, the invention provides an electric motor including a single end frame having a conduit box and a lead wire window in communication with the conduit box. The lead wire window is fully enclosed by the end frame. The electric motor also includes electrical components for operation of the electric motor, a stator, lead wires for energization of the stator, a shaft, and a rotor. The electrical components are at least partially positioned in the conduit box. The stator is fixed relative to the end frame. The lead wires extend from the stator through the lead wire window and into the conduit box for connection to at least one of the electrical components. The shaft is supported by the end frame for rotation about a shaft axis. The rotor has opposite sides spaced in the direction of the shaft axis and is connected to the shaft for rotation with the shaft relative to the stator. The shaft is supported on only one side of the rotor for rotation about the shaft axis.

Further objects of the present invention together with the organization and manner of operation thereof, will become apparent from the following detailed description of the invention when taken in conjunction with the accompanying drawings wherein like elements have like numerals throughout the drawings.

### BRIEF DESCRIPTION OF THE DRAWINGS

The present invention is further described with reference to the accompanying drawings, which show an embodiment of the present invention. However, it should be noted that the invention as disclosed in the accompanying drawings is illustrated by way of example only. The various elements and combinations of elements described below and illustrated in the drawings can be arranged and organized differently to result in embodiments which are still within the spirit and scope of the present invention. Also, it is understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” are used broadly and encompass both direct and indirect mountings, connections, supports, and couplings. Further, “connected” and “coupled” are not restricted to physical or mechanical connections or couplings. The use of “hydromassage bathtub,” “whirlpools,” “jetted bathtubs,” and variations thereof herein is meant to encompass drainable fluid-holding apparatus that include pumps for pumping fluid (e.g., water, air) through fluid jets in the fluid-holding apparatus.

FIG. 1 illustrates a first perspective view of an electric motor according to a first embodiment of the invention.

FIG. 2 illustrates a second perspective view of the electric motor illustrated in FIG. 1.

FIG. 3 illustrates an exploded view of the electric motor illustrated in FIG. 1.

FIG. 4 illustrates a sectional view of the electric motor illustrated in FIG. 1.

FIG. 5 illustrates a perspective view of an end frame of the electric motor illustrated in FIG. 1.

FIG. 6 illustrates a front view of an end frame of the electric motor illustrated in FIG. 1.

FIG. 7 illustrates an exploded view of an electric motor according to a second embodiment of the invention.

FIG. 8 illustrates a sectional view of the electric motor illustrated in FIG. 7.

FIG. 9 illustrates a perspective view of a canopy of the electric motor illustrated in FIG. 7.

### DETAILED DESCRIPTION

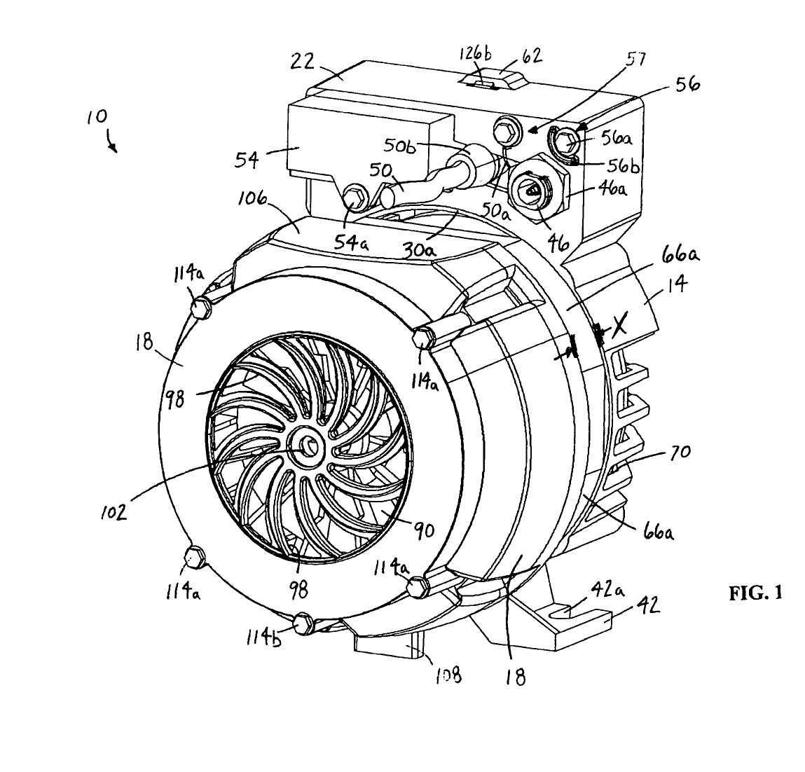

FIGS. 1-4 illustrate an electric motor 10 according to the invention. In some embodiments, the motor 10 may be drivingly connected to a load such as a fluid pump for pumping fluid through fluid jets in a hydromassage bathtub. In other embodiments, other types of loads may be drivingly connected to the motor 10.

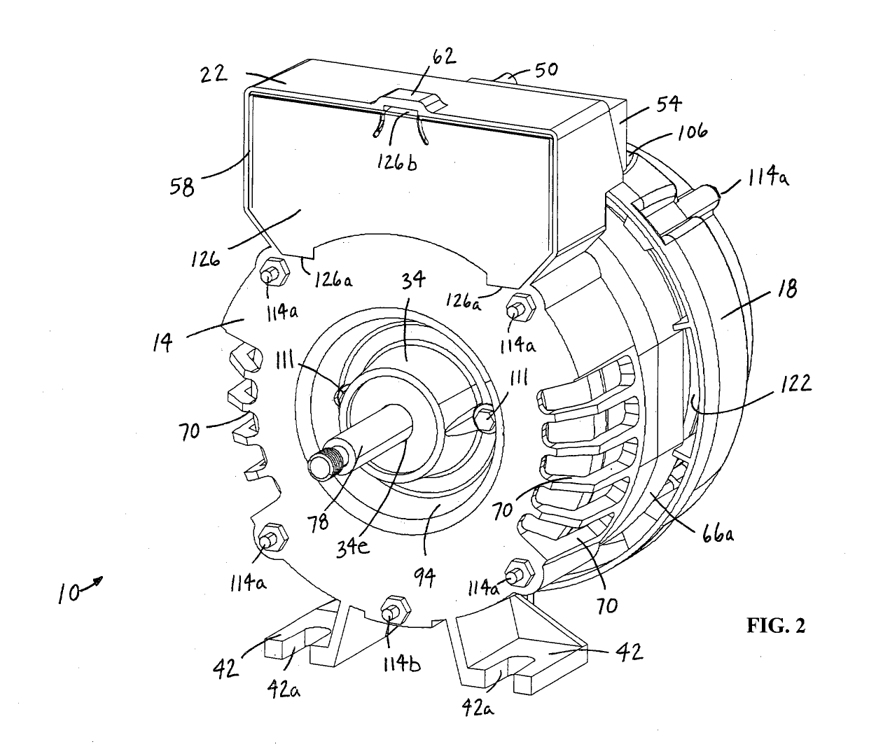

With references to FIGS. 1 and 2, the motor 10 includes a housing having a single end frame 14 and a canopy 18. Prior art electric motors that are utilized to drive pumps associated with hydromassage bathtubs commonly include a housing having two end frames, each end frame supporting a portion of the shaft on opposite sides of the rotor. Use of the single end frame 14 allows for support of the shaft on only one side of the rotor as the canopy 18 does not support the shaft for rotation about the shaft axis. Although the axial length of the motor 10 is shortened when compared to prior art electric motors having two end frames, enhanced manufacturing techniques are required to ensure proper operation of the motor 10. The motor 10 not only eases installation and maintenance, but also reduces manufacturing costs when compared to prior art electric motors utilized for hydromassage bathtub applications.

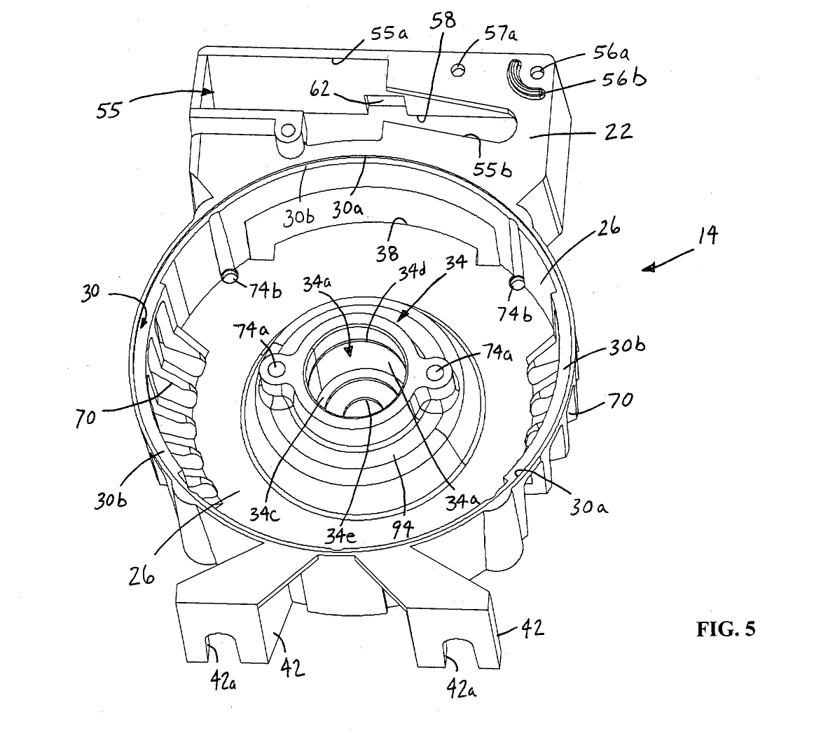

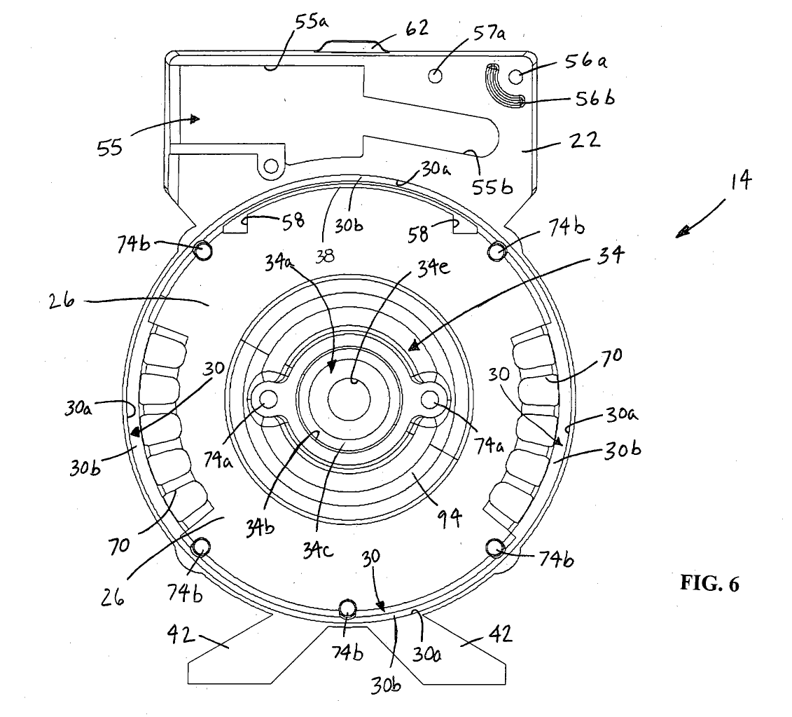

With reference to FIGS. 5-6, the end frame 14 includes a conduit box 22, a stator receiving portion 26, a stator locating member 30, a bearing hub 34, a lead wire window 38, and support bases 42.

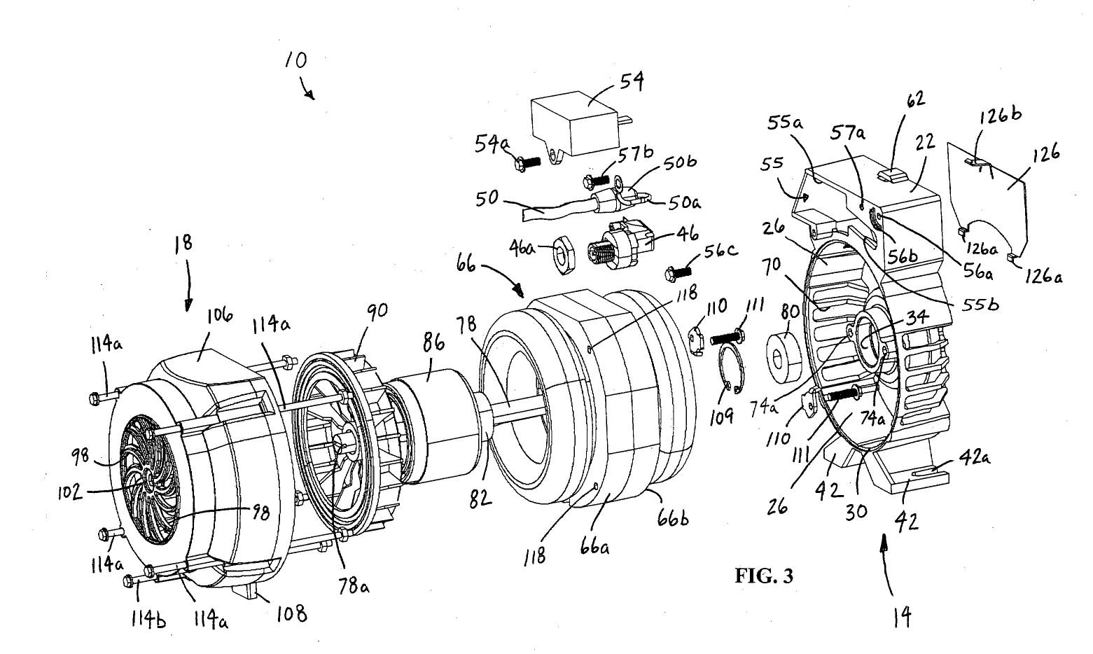

As best shown in FIGS. 1 and 3, the conduit box 22 is sized to receive an air switch 46, a power cord 50, and a capacitor 54. In other embodiments, the conduit box 22 may be sized to receive other electrical components utilized for the operation of the motor 10. The air switch 46 is connected via a pneumatic line to a switch located for actuation by an occupant of the hydromassage bathtub. Use of the air switch 46 allows the occupant to control the operation of the motor 10, and thereby the flow of fluid through the fluid jets, during use of the hydromassage bathtub. The air switch 46 also electrically isolates the occupant from the electrical components of the motor 10. The power cord 50 may either removably or permanently connect the motor 10 to a power source. The capacitor 54 is utilized or energization of the motor 10.

With reference to FIGS. 5-6, the conduit box 22 includes a surface that defines an aperture 55. The aperture 55 is fully enclosed by the surface and includes a main portion 50a and a slot portion 50b. The aperture 55 may be alternatively configured in other embodiments. With reference to FIGS. 1-2, the conduit box 22 also includes a bonding apparatus 56, a grounding apparatus 57, an access aperture 58, and a brace 62.

With reference to FIG. 3, the bonding apparatus 56 includes a bonding aperture 56a and a curved wall 50b positioned adjacent to the bonding aperture 50a. A bonding wire is captured between the conduit box 22 and the head of a bonding fastener 50c when the bonding fastener 50c is received in the bonding aperture 50a. The curved wall 50b prevents the wire from moving out from under the head of the bonding fastener 50c during normal operation of the motor 10. As is known in the art, the bonding wire is electrically connected to other conductive material in a bonding area of the hydromassage bathtub to reduce shock hazards in the bonding area.

The grounding apparatus 57 includes a grounding aperture 50a located adjacent the slot portion 50b. As illustrated in FIG. 1, a connector on an end portion of a grounding wire 50a of the power cord 50 is captured between the conduit box 22 and a grounding faster 50b when the grounding fastener 50b is received in the grounding aperture 50a.

In the illustrated embodiment, the conduit box 22 is integrally connected or formed with the remainder of the end frame 14. In some embodiments, integrally forming the conduit box 22 with the remainder of the end frame 14 allows the conduit box to be minimally sized. Such sizing reduces the overall size of the motor 10 and contributes to the ease of installation and maintenance of the motor 10. In other embodiments, the conduit box 22 may be removably or permanently fixed to the remainder of the end frame 14.

The stator receiving portion 26 is sized to receive a portion of a stator 66. The stator 66 includes a stator core having a generally cylindrical portion 60a that is centered on the shaft axis during normal operation of the motor 10 and a planar portion 60b that is transverse (e.g., perpendicular) to the shaft axis during normal operation of the motor 10. As illustrated in FIG. 3, the generally cylindrical portion 60a includes a number of non-cylindrical portions. However, the non-cylindrical portions are not required to practice the invention. The stator 66 also includes lead wires (not shown) utilized to energize the stator 66. The stator receiving portion 26 also includes air vents 70 and bores 74.

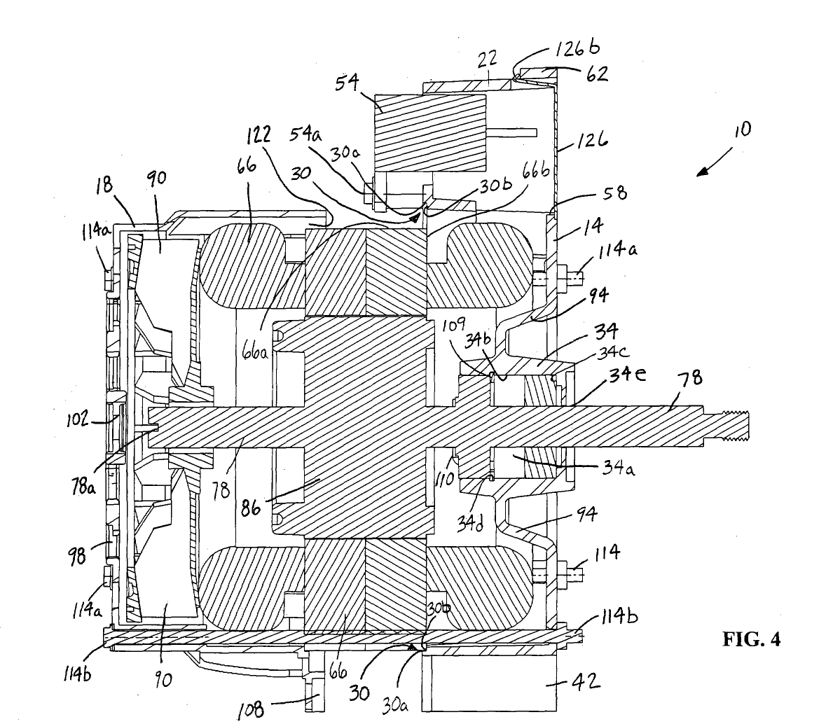

As best illustrated in FIGS. 4-6, the stator locating member 30 includes a continuous cylindrical surface 30a that is centered on the shaft axis during normal operation of the motor 10 and a continuous planar surface 30b that is transverse (e.g., perpendicular) to the shaft axis during normal operation of the motor. The planar surface 30b lies in a single plane. The stator locating member 30 may be alternatively configured in other embodiments.

The bearing hub 34 is sized to support a rotating assembly of the motor 10. With reference to FIG. 3, the rotating assembly includes a shaft 78, a first bearing 80, a second bearing 82, a rotor 86 connected to the shaft 78 for rotation therewith about the shaft axis, and a fan 90 connected to the shaft 78 for rotation therewith about the shaft axis. With reference to FIGS. 4-6, the bearing hub 34 defines a bearing bore 30a having a cylindrical surface 30b centered on the shaft axis during normal operation of the motor 10 and a planar surface 30c that is transverse (e.g., perpendicular) to the shaft axis during normal operation of the motor 10. As illustrated in FIG. 5, the cylindrical surface 30b defines an annular groove 30d. As illustrated in FIG. 2, the planar surface 30c defines a shaft aperture 30e. The bearing bore 30a is sized to receive the first and second bearings 80 and 82. The shaft 78 is fully supported by the first and second bearings 80 and 82, thereby allowing the shaft 78, and the rotor 86 and the fan 90 which are each connected to the shaft 78, to rotate about the shaft axis. As shown in FIG. 3, the shaft 78 includes an end portion 70a that can be engaged with a tool for manipulation of a load to which the shaft 78 is, or is being, drivingly connected. In the illustrated embodiment, the end portion 70a includes a screwdriver slot for engagement by a screwdriver. In other embodiments, the end portion 70a may include any surface that is adapted for engagement by a tool to either rotate the shaft 78 or hold the shaft 78 stationary.

The bearing hub 34 is supported by a concave portion 94 of the end frame 14. As illustrated in FIG. 4, the concave portion 94 extends inward to engage a middle portion of the bearing hub 34. The bearing hub 34 supports the first and second bearings 80 and 82 directly adjacent the rotor 86 and radially inward of the stator 66. Such support of the bearings 80 and 82 minimizes the axial length of the motor 10 and enhances the operation of the motor 10 by increasing the stability of the shaft 78, thereby maintaining a consistent air gap between the stator 66 and the rotor 86.

With reference to FIG. 5, the lead wire window 38 is fully enclosed by the end frame 14 and communicates with the conduit box 22. Full enclosure of the lead wire window 38 allows the stator locating member 30 to be continuous. In one embodiment, the end frame 14 is cast of aluminum and the stator locating member 30 and the bearing bore 30a are machined such that the cylindrical surface 30a and the cylindrical surface 30b are concentric about the shaft axis during normal operation of the motor and the planar surface 30b and the planar surface 30c are each transverse (e.g., perpendicular) to the shaft axis during normal operation of the motor 10. The stator locating member 30 is machined from a continuous surface of the cast end frame 14 using a precision tenon machining process. The machining process is accomplished in a continuous fashion which eliminates any vibration due to stoppage of the machining process. Such vibration can affect the precision of the machined surface. The bearing bore 30a is machined from the bearing hub 34 to ensure the bearings 80 and 82 properly support the remainder of the rotating assembly for rotation about the shaft axis.

With reference to FIGS. 1-6, the support bases 42 are sized to support the motor 10 during normal operation. As discussed further below, the canopy 18 may also include a support base to assist in the support of the motor 10. The support bases 42 each include a notch 40a sized to receive a fastener which may be utilized to removably connect each support base 42 to a supporting surface.

The canopy 18 is configured to house or cover a portion of the stator 66 and a portion of the rotating assembly during normal operation of the motor 10. The canopy 18 includes air vents 98 and a shaft access aperture 102. The air vents 98 cooperate with the fan 90 to allow cooling air to pass through the motor compartment. The shaft access aperture 102 provides access to the end portion 70a of the shaft 78. The shaft access aperture 102 is illustrated as a round hole sized to receive a screw driver. In other embodiments, the shaft access aperture 102 may be alternatively sized and/or include an alternative shape. The canopy 18 also includes a flat portion 106 which allows for unencumbered access to the conduit box 22 when the motor 10 is assembled, and a support base 108 that works in combination with the support bases 42 to support the motor 10 during normal operation. In the illustrated embodiment, the canopy 18 is formed of plastic using an injection molding process.

For assembly of the motor 10, the end frame 14 is supported on a horizontal surface. The air switch 46 is installed by inserting the connector portion of the air switch 46 through the main portion 50a of the aperture 55 and sliding the air switch 46 into the slot portion 50b of the aperture 55 so the threaded portion of the air switch 46 extends from the conduit box 22 through the slot portion 50b. The air switch 46 is then secured to the surface of the conduit box 22 adjacent the slot portion 50b with a hex nut 40a. The power cord 50 is installed by securing the grounding wire 50a to the grounding apparatus 57 and inserting the connector portion of the power cord 50 through the main portion 50a of the aperture 55 and sliding the power cord 50 into the slot portion 50b of the aperture 55 to a position adjacent the air switch 46 so a slot in the strain relief 50b of the power cord 50 is engaged by the surface of the conduit box 22 adjacent the slot portion 50b. The power cord 50 prevents movement of the air switch 46 in the slot portion 20b. The capacitor 54 is installed by inserting the connector portion of the capacitor through the main portion 50a of the aperture 55 and securing the capacitor 54 to the conduit box 22 using a single fastener 50a. The capacitor 54 prevents movement of the power cord 50 and the air switch 46 in the slot portion 50b.

The stator 66 is located relative to the end frame 14 by the stator locating member 30. Due to the precision machining of the stator locating member 30 as explained above, an excellent alignment between the end frame 14 and stator 66 is achieved without requiring additional manufacturing processes, thus simplifying the manufacturing of the motor 10. The cylindrical portion 60a of the stator core is radially supported by the cylindrical surface 30a of the stator locating member 30 and the planar portion 60b of the stator core is axially supported by the planar surface 30b of the stator locating member 30.

The rotating assembly is installed by first inserting the first bearing 80 into the bearing bore 30a so the first bearing 80 is axially supported by the planar surface 30c. A retaining ring 109 (FIG. 3) is then inserted in the groove 30d. The second bearing 82, which is press fit on the shaft 78, is then inserted into bearing bore 30a so the second bearing 82 is axially supported by the retaining ring 109 and the shaft 78 extends through the shaft aperture 30e. Bearing clips 110 (FIG. 3) are used to fix the second bearing 82 and the remainder of the rotating assembly in place. The bearing clips 110 are fixed to the end frame by fasteners 111 (FIG. 3). In the illustrated embodiment, the fasteners 111 are bolts that extend through corresponding bores 70a in the end frame. The bearing hub 34 fully supports the rotating assembly during operation of the motor 10. As best shown in FIG. 4, the first and second bearings 80 and 82 are spaced from each other. Support of the bearings 80 and 82 by the bearing bore 30a in a spaced relationship substantially reduces bearing creep which would otherwise tend to prematurely wear the bearing bore 30a and thus affect the support of the rotating assembly by the bearing bore 30a. In other embodiments, the rotating assembly may be supported by fewer or more bearings positioned on a single side of the rotating assembly.

The canopy 18 is connected to the end frame 14 using fasteners 114. In the illustrated embodiment, the fasteners 114 include bolts that extend through corresponding bores 118 in the stator core and corresponding bores 70b in the end frame 14. As illustrated in FIG. 2, nuts are utilized to retain the fasteners 114 during manufacturing of the motor 10. In some embodiments, the nuts of the fasteners 110a are removed when the motor 10 is connected to a load and the fasteners 110a are received by the load to connect the motor 10 to the load. The fastener 110b is utilized to maintain the stator 66 in a fixed relationship relative to the end frame 14 when connecting the motor 10 to the load.

As illustrated in FIGS. 2 and 4, air vents 122 are formed between the canopy 18 and the stator core when the motor 10 is assembled. In some embodiments, a portion of the stator core is exposed between the canopy 18 and the end frame 14 during normal operation of the motor 10. This exposure of the stator core allows motors having different performance specifications to be manufactured using the same end frame 14 and canopy 18. Larger horsepower motors generally include stators and rotors that are axially larger than the stators and rotors of smaller horsepower motors. Prior art motors also commonly include differently sized housings to accommodate these variations in components. The housing (i.e., the end frame 14 and the canopy 18) of the invention can be utilized in the production of motors having differently sized stators and rotors simply by using differently sized fasteners 114. The amount of stator core exposed between the canopy 18 and the end frame 14 is generally larger for larger horsepower motors and smaller for smaller horsepower motors.

After all mechanical assembly processes are completed, the motor 10 is reoriented and the electrical connections are made through the access aperture 58. The lead wires extend through the lead wire window 38 and are electrically connected to the electrical components. The connections between the electrical components and the lead wires may vary based on the configuration of the motor 10. In other embodiments, the electrical connections can be made when installing the electrical components in the conduit box 22, thereby eliminating the need for the access aperture 58. When the electrical connections are completed, a cover 126 is utilize to cover the access aperture 58. The cover 126 includes tabs 120a on a bottom portion of the cover 126 and a hook 120b on a top portion of the cover 126. The tabs 120a engage the surface of the end frame 14 adjacent the access aperture 58 and the hook 120b is snapped into the brace 62. The cover 126 is only removable by using a tool such as a screw driver to depress the hook 120b and disengage the hook 120b from the brace 62. However, as discussed further below, the cover 126 generally does not need to be removed as maintenance of the electrical components can be accomplished by accessing the electrical components through the aperture 55.

As illustrated in FIGS. 1 and 2, the air switch 46, power cord 50, and capacitor 54 extend through the conduit box 22 in a direction opposite the direction of the load connection. Such orientation avoids any interference between the electrical components and the load. Additionally, such a configuration allows for complete mechanical assembly of the motor 10 without flipping the motor 10, thereby simplifying the manufacturing process.

For field service of the motor 10, the field service technician only needs to remove the electrical components through the main portion 50a of the aperture 55 to perform standard maintenance. The field service technician does not need to remove any portion of the housing as is commonly required to perform maintenance on prior art motors. Removing a portion of the housing increases the likelihood that the factory provided motor alignment may be compromised. If the motor alignment is compromised, the operation of the motor is effected. Accordingly, the design of the motor 10 not only reduces the time required to perform maintenance, but also reduces the probability of compromising the operation of the motor 10.

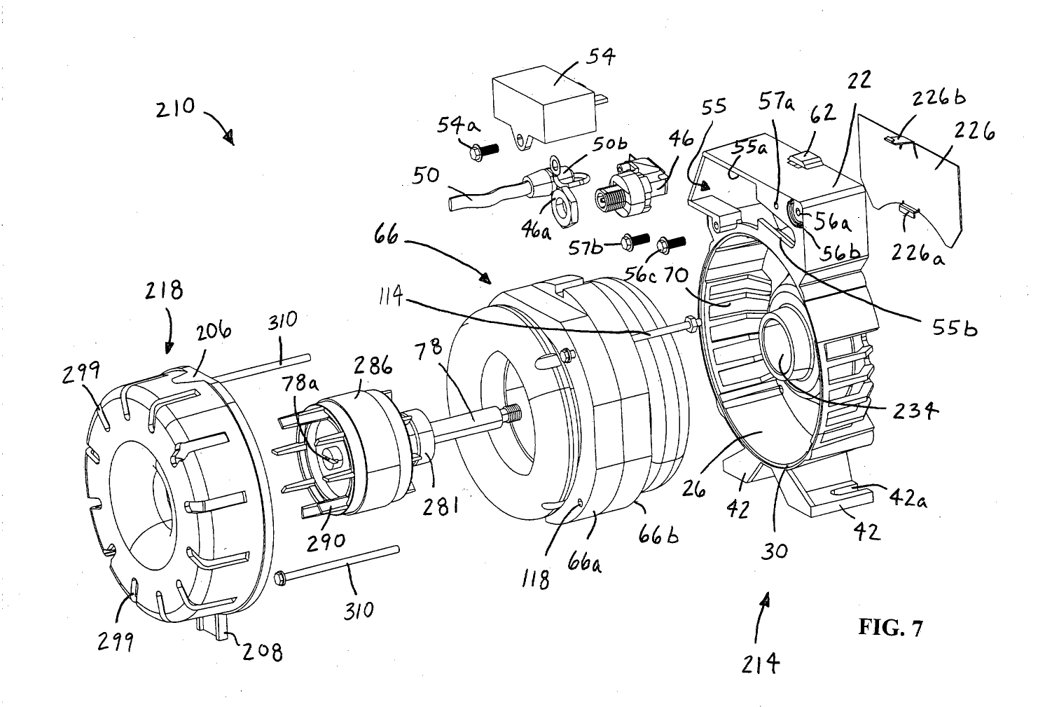

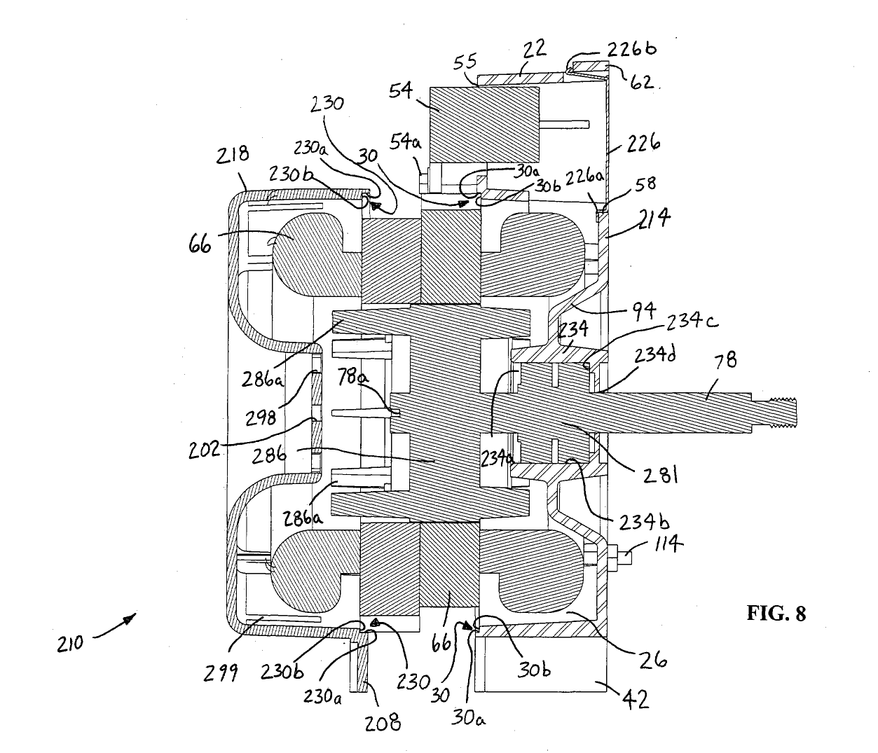

FIGS. 7 and 8 illustrate a motor 210 according to another embodiment of the invention. The motor 210 is similar to the motor 10 and accordingly, only the differences between the two motors 210 and 10 are discussed herein. Components of the motor 210 that are similar to the components of the motor 10 are indicated using like numerals throughout the specification and the drawings.

The motor 210 includes an end frame 214 that includes a bearing hub 234. The bearing hub 234 is sized to support a rotating assembly of the motor 210. With reference to FIG. 7, the rotating assembly includes a shaft 78, a bearing assembly 281, and a rotor 286 connected to the shaft 78 for rotation therewith about the shaft axis. The rotor 286 includes an integrally formed fan 280a. In some embodiments, the fan 280a eliminates the need for a separate fan similar to the fan 90. The bearing assembly 281 is press fit on the shaft 78 and includes two ball bearings spaced by a wave spring which compensates for axial variation in the bearings, thereby reducing noise generated during normal operation of the motor 210. The bearing hub 234 defines a bearing bore 230a having a cylindrical surface 230b centered on the shaft axis during normal operation of the motor 210 and a planar surface 230c that is transverse (e.g., perpendicular) to the shaft axis during normal operation of the motor 210. As illustrated in FIG. 8, the planar surface 230c defines a shaft aperture 230d. The bearing bore 230a is sized to receive the bearing assembly 281. The shaft 78 is fully supported by the bearing assembly 281, thereby allowing the shaft 78, and the rotor 286 which is connected to the shaft 78, to rotate about the shaft axis.

A cover 226 is utilize to cover the access aperture 58. The cover 226 includes a tab 220a on a bottom portion of the cover 226 and a hook 220b on a top portion of the cover 226. The tab 220a engages the surface of the end frame 214 adjacent the access aperture 58 and the hook 220b is snapped into the brace 62.

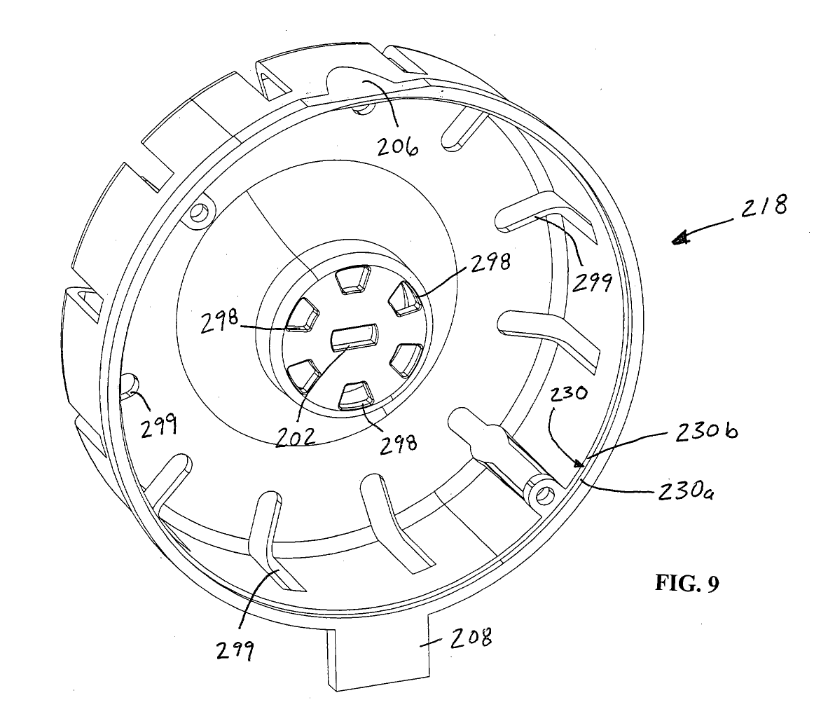

With reference to FIGS. 7-9, the motor 210 includes a canopy 218. The canopy includes air vents 298, air vents 299, a shaft access aperture 202, a support base 208, and a flat portion 206. The air vents 298 and 299 cooperate with the fan 280a to allow cooling air to pass through the motor compartment. Air vents similar to the air vents 122 are not formed between the canopy 218 and the stator core when the motor 210 is assembled. The canopy 218 includes a concave portion that closely matches the contour of the fan 280a. The interaction between the fan 280a and the canopy 218 provides an efficient cooling operation which minimized the axial length of the motor 210 by eliminating a fan similar to the fan 90. The shaft access aperture 202 provides access to the end portion 70a of the shaft 78. The shaft access aperture 202 is illustrated as a slot sized to receive a screw driver. The support base 208 works in combination with the support bases 42 to support the motor 210 during normal operation. The flat portion 206 allows for unencumbered access to the conduit box 22 when the motor 210 is assembled.

The canopy 218 also includes a canopy locating member 230 sized similar to the stator locating member 30. The canopy locating member 230 includes a cylindrical surface 230a centered on the shaft axis during normal operation of the motor 210 and a planar surface 230b that is transverse (e.g., perpendicular) to the shaft axis during normal operation of the motor 210. The canopy locating member 230 locates the canopy 218 with respect to the stator core. The precision utilized in the formation of the stator locating member 30 is not required for the canopy locating member 230 as the canopy 218 does not have a direct affect on the interaction between the stator 66 and the rotor 286. In the illustrated embodiment, the canopy 218 is formed of plastic using an injection molding process.

The stator 66 is fixed relative to the end frame 214 using fasteners 310. In the illustrated embodiment, the fasteners 310 are self-forming screws. The fasteners 310 are received in corresponding bores in the end frame 214. The fasteners 310 maintain the alignment between the stator 66 and the end frame 214 when removing nuts from fasteners 114 for connection to of the motor 210 to a load.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims.

1. An electric motor comprising:
a single end frame having a bearing support surface;
a stator having a stator core, a first end fixed relative to the end frame, and a second end remote from the end frame;
a bearing substantially engaged with the bearing support surface;
a shaft supported by the bearing for rotation about a shaft axis;
a rotor having opposite sides spaced in the direction of the shaft axis, the rotor being connected to the shaft for rotation with the shaft relative to the stator, the shaft being supported on only one side of the rotor for rotation about the shaft axis; and
a canopy fixed relative to the end frame and configured to cover at least a portion of the rotor and the second end of the stator during normal operation of the electric motor, a portion of the stator core being exposed between the end frame and the canopy at all times during normal operation of the electric motor, the shaft not being supported by the canopy for rotation about the shaft axis.

2. An electric motor as claimed in claim 1 wherein the electric motor is configured to selectively include one of a first performance specification and a second performance specification, the first performance specification requiring the stator core have a first axial length being exposed between the canopy and the end frame, the second performance specification requiring the stator core have a second axial length being exposed between the canopy and the end frame, and wherein the first axial length is smaller than the second axial length.

3. An electric motor as claimed in claim 1 and further comprising electrical components for operation of the electric motor, wherein the shaft is configured to be drivingly connected to a load, wherein the end frame includes a conduit box, and wherein the electrical components are at least partially positioned in the conduit box so a portion of at least one of the electrical components extends outside of the conduit box in a direction away from the load connection during normal operation of the electric motor.

4. An electric motor as claimed in claim 1 and further comprising electrical components for operation of the electric motor and lead wires for energization of the stator, wherein the end frame includes a conduit box and a lead wire window in communication with the conduit box, the lead wire window being fully enclosed by the end frame, wherein the electrical components are at least partially positioned in the conduit box, and wherein the lead wires extend from the stator through the lead wire window and into the conduit box for connection to at least one of the electrical components.

5. An electric motor as claimed in claim 1 wherein the end frame includes a surface that is transverse to the shaft axis and that axially locates the stator with respect to the end frame.

6. An electric motor as claimed in claim 5 wherein the surface that is transverse to the shaft axis lies in a single plane.

7. An electric motor as claimed in claim 5 wherein the end frame includes a generally cylindrical surface that is centered on the shaft axis and that radially locates the stator with respect to the end frame.

8. An electric motor as claimed in claim 1 wherein the canopy includes a support base configured to support at least a portion of the electric motor during normal operation of the electric motor.

9. An electric motor as claimed in claim 1 wherein the shaft is drivingly connected to a fluid pump for pumping fluid through fluid jets in a hydromassage bathtub.

10. An electric motor comprising:
a single end frame including a conduit box;
a stator having a first end fixed relative to the end frame and a second end remote from the end frame;
a shaft supported by the end frame for rotation about a shaft axis;
a rotor having opposite sides spaced in the direction of the shaft axis, the rotor being connected to the shaft for rotation with the shaft relative to the stator, the shaft being supported on only one side of the rotor for rotation about the shaft axis;
a canopy configured to cover at least a portion of the rotor and the second end of the stator during normal operation of the electric motor, the shaft not being supported by the canopy for rotation about the shaft axis; and
electrical components for operation of the electric motor, the electrical components being at least partially positioned in the conduit box, the electrical components being removable from the conduit box without removing the canopy.

11. An electric motor as claimed in claim 10 wherein the electrical components include a capacitor, a power cord, and an air switch, and wherein the capacitor is removable from the conduit box without removing the other electrical components.

12. An electric motor as claimed in claim 11 wherein one of the power cord and the air switch is removable from the conduit box without removing an other one of the power cord and the air switch from the conduit box.

13. An electric motor as claimed in claim 12 wherein the other of the power cord and the air switch is removable from the conduit box solely by removing the capacitor, the one of the power cord and the air switch, and the other of the power cord and the air switch from the conduit box.

14. An electric motor as claimed in claim 10 wherein the electrical components include a capacitor, a power cord, and an air switch, wherein the conduit box includes a surface defining an aperture, the aperture having a main portion and slot portion extending from the main portion, and wherein a portion of the air switch and a portion of the power cord are each received in the slot portion and a portion of the capacitor is received in the main portion.

15. An electric motor as claimed in claim 10 wherein the conduit box includes a surface defining an aperture, the aperture being fully enclosed by the surface, wherein the electrical components include an air switch, the air switch being connected to the surface of the conduit box adjacent the aperture so the air switch extends through the aperture during normal operation of the electric motor, and wherein the air switch is removable from the conduit box by removing the portion of the air switched located inside the conduit box through the aperture.

16. An electric motor as claimed in claim 10 wherein the stator includes a stator core, and wherein a portion of the stator core is exposed between the canopy and the end frame at all times during normal operation of the electric motor.

17. An electric motor as claimed in claim 10 wherein the shaft is configured to be drivingly connected to a load, and wherein the electrical components are at least partially positioned in the conduit box so a portion of at least one of the electrical components extends outside of the conduit box, the portion of the at least one of the electrical components that extends outside of the conduit box extending in a direction away from the load connection.

18. (Canceled)

19. (Canceled)

20. (Canceled)

21. (Canceled)

22. (Canceled)

23. (Canceled)

24. (Canceled)

25. (Canceled)

26. (Canceled)

27. An electric motor comprising:
a single end frame including a conduit box and a lead wire window in communication with the conduit box, the lead wire window being fully enclosed by the end frame;
electrical components for operation of the electric motor, the electrical components being at least partially positioned in the conduit box;
a stator fixed relative to the end frame;
lead wires for energization of the stator, the lead wires extending from the stator through the lead wire window and into the conduit box for connection to at least one of the electrical components;
a shaft supported by the end frame for rotation about a shaft axis; and
a rotor having opposite sides spaced in the direction of the shaft axis, the rotor being connected to the shaft for rotation with the shaft relative to the stator, the shaft being supported on only one side of the rotor for rotation about the shaft axis.

28. An electric motor as claimed in claim 27 wherein the end frame includes a stator locating member that locates the stator with respect to the end frame.

29. An electric motor as claimed in claim 28 wherein the stator locating member includes a continuous surface.

30. An electric motor as claimed in claim 7 wherein the end frame includes a bearing hub that defines a bearing bore having the bearing support surface, wherein the bearing support surface is generally cylindrical, and wherein the cylindrical surface of the end frame and the cylindrical surface of the bearing bore are concentric about the shaft axis.

31. An electric motor as claimed in claim 5 wherein the end frame comprises a bearing hub comprising the bearing support surface, wherein the bearing hub defines a bearing bore having a surface that is transverse to the shaft axis, and wherein the surfaces of the end frame and the bearing bore that are transverse to the shaft axis are each perpendicular to the shaft axis.

32. An electric motor as claimed in claim 1 and further comprising a second bearing substantially engaged with the bearing support surface, wherein the shaft is further supported by the second bearing for rotation about the shaft axis, wherein the end frame defines a bearing hub comprising the bearing support surface, wherein the bearing support surface includes a groove sized to receive a retaining ring, and wherein the first bearing and second bearing are supported by the bearing so that the first bearing is spaced from the second bearing by the retaining ring.

33. An electric machine as set forth in claim 1, wherein the electric motor includes a fastener engaging the single end frame and the canopy.
